(19) United States
(12) Patent Application Publication
(10) Pub. No.: US 2015/0266416 A1
(43) Pub. Date: Sep. 24, 2015

(54) CONVERTER SLAVED IN TERMS OF OUTPUT CURRENT

(71) Applicant: Valeo Vision, Bobigny Cedex (FR)

(72) Inventor: Sebastian KRICK, Paris (FR)

(21) Appl. No.: 14/663,670

(22) Filed: Mar. 20, 2015

(30) Foreign Application Priority Data
Mar. 21, 2014 (FR) 1452413

(51) Int. Cl. B60Q 3/00; H05B 33/08; H02M 3/156

(52) U.S. Cl. CPC B60Q 3/00; H02M 3/156; H05B 33/0815

(57) ABSTRACT

The invention relates to a converter of SEPIC type intended to convert a first DC voltage into a different second DC voltage. The converter is noteworthy in that it allows a slaving in terms of output current by way of an indirect measurement which is sensitive neither to the coefficient of coupling between the inductors L1 and L2, nor to the ratio L1/L2.

### CROSS-REFERENCE TO RELATED APPLICATION

This application claims priority to French Application No. 1452413 filed on Mar. 21, 2014, which application is incorporated herein by reference and made a part hereof.

### BACKGROUND OF THE INVENTION

1. Field of the Invention

The invention deals with the field of DC voltage converters, especially of the switched-mode power supply type, SEPIC. More precisely, the invention deals with a converter of SEPIC type slaved in terms of output current, so as to supply at least one light-emitting diode, LED.

2. Description of the Related Art

FIG. 1 shows a diagram of a SEPIC converter such as it is known in the prior art. The SEPIC converter, the acronym stemming from the expression “single ended primary inductor converter” is a switched-mode power supply which serves to convert a first DC voltage VIN into a second DC voltage VOUT, of different value, either smaller or bigger than the first DC voltage. The value of the output voltage depends on the duty ratio of closing of the switch S1. When the switch is open, the two inductors L1 and L2 supply the load circuit RLOAD with current across the diode D1. When the switch is closed, the voltage source charges the inductor L1 while the first capacitor C1 charges the second inductor L2. The load circuit is then supplied with current by the second capacitor C2. It is also possible to replace the two inductors L1 and L2 by two coupled inductors on the same magnetic circuit.

For a number of applications of this type of converter, and especially in the case where it is used to supply one or more light-emitting diodes, LED, it is important that the load current generally be constant over time. Indeed, the luminous intensity of an LED is a function of the current which supplies it. The load voltage is a consequence of the type and of the number of LEDs mounted as load. In order to guarantee a generally constant load current or output current, it is necessary to slave the output current to the converter. The measurement of output current cannot be carried out by a shunt at the converter output for reasons of protection of the outputs. This is particularly important in the automobile sector, which is resorting ever more to LED technology for luminous signaling solutions.

It is known to measure the output current of a converter of SEPIC type by indirect pathway. Indeed, the mean current passing through the secondary inductor L2 is equal to the output current. The measurement of this current downstream of L2 is therefore a presumed candidate for the slaving of the output current. This measurement is correct only if the coupled inductors L1 and L2 are exactly equal. In the practical case of two distinct inductors, the distribution of the ripple currents depends on the factor L1/L2 and on the coefficient of coupling k between L1 and L2. It is difficult to control these quantities. By default, and in practice, an imbalance of the ripple currents may be created. By superposition with the current which passes through L2 during the operation of the converter, the resulting current which is presumed to represent the output current of the converter, may change sign without the average of the current in L2 changing. Failing the use of a symmetric power supply, the amplifiers of the potential measured between the node N4 and the ground are not capable of correctly amplifying a signal which changes sign. Consequently, such a measurement which would serve for the slaving would be falsified and this error would be retransmitted to the output current. An illustration of this behavior of a converter known from the prior art is provided by FIGS. 2A, 2B and 2C respectively. FIG. 2A shows the temporal evolution of the voltage between the fourth node N4 and the ground. FIG. 2B shows the same signal amplified by an operational amplifier. FIG. 2C shows the corresponding evolution of the currents passing through the inductors L1 and L2 respectively. The circle superposed on FIGS. 2A and 2B highlights a change of sign of the voltage measured between the node N4 and the ground.

### SUMMARY OF THE INVENTION

The objective of the invention is to propose a converter of SEPIC type alleviating at least one of the drawbacks of the prior art. More precisely, the objective of the invention is to propose a converter in which a value representative of the instantaneous output current is measured in an indirect manner downstream of the secondary inductor, so as to be slaved to the converter.

The subject of the invention is a converter of SEPIC type intended to convert a first DC voltage into a different second DC voltage. The converter comprises:
a first node N1, which serves to connect a voltage source linked to ground, which provides the first voltage VIN;
a first inductor L1 coupled to the first node N1 and to a second node N2;
a switch S1 comprising a first contact coupled to the second node N2, and a second contact coupled to ground;
a first capacitor C1 coupled to the second node N2 and to a third node N3;
a second inductor L2 coupled to the third node N3 and to a fourth node N4;
a diode D1 mounted between the third node N3 and a fifth node N5 in such a way that a current can flow from the third node N3 to the fifth node N5, which serves to connect a load circuit linked to ground;
a second capacitor C2 coupled to the fifth node N5 and to ground;
a measurement resistor or shunt Rs mounted between the fourth node N4 and the ground.

The converter is noteworthy in that it comprises a branch which links the first node N1 to the fourth node N4, and which comprises a third capacitor C3.

Preferably, the converter is supplied by an electric battery, such as a battery of an automotive vehicle.

The third capacitor C3 can preferably be rated in such a way that the potential difference between the fourth node N4 and the ground does not change sign during the operation of the converter. In an advantageous manner, the third capacitor C3 can be rated in such a way that the potential difference between the fourth node N4 and the ground exhibits variations of less than 100 mV during the operation of the converter. In a still more advantageous manner, the third capacitor C3 can be rated in such a way that the potential difference between the fourth node N4 and the ground remains constant during the operation of the converter.

Preferably, the value of the first inductor L1 can be different from the second inductor L2 and the two inductors can be coupled.

The switch can preferably be a transistor, for example a MOSFET insulated gate field-effect transistor.

The subject of the invention is also a device for driving the electrical power supply of light-emitting diodes, LED, for an automotive vehicle. The device comprises a converter of SEPIC type, which is noteworthy in that it is in accordance with the converter according to the invention.

The device can preferably comprise current measurement means, disposed so as to measure the electric current between the fourth node N4 and the ground. The measurement corresponds to an indirect measurement of the output current of the converter. The converter is preferably slaved in terms of output current through the indirect measurement thus obtained of the output current.

The device can comprise an input capacitor CIN, coupled to the first node N1 and to ground, mounted in parallel with the voltage source.

The subject of the invention is also a luminous device for automotive vehicle, especially a lighting or signaling device, comprising a plurality of LEDs and a device for driving the power supply of the plurality of LEDs. The device is noteworthy in that the driving device is in accordance with the invention.

The subject of the invention is also a method of power supply of at least one light-emitting diode, LED, mounted as load circuit of a converter of SEPIC type according to the invention, supplied by a first voltage source VIN. The method is noteworthy in that it comprises the steps of:
indirect measurement of the output current of the converter by measurement of the electric current between the node N4 and the ground;
slaving of the converter in terms of output current through the indirect measurement.

Preferably at least two light-emitting diodes, LED, are mounted in series in the load circuit.

The invention makes it possible to propose a converter of SEPIC type, capable of converting an input voltage into an output voltage which is either higher or lower than the input voltage, and capable especially of supplying a load circuit by a current of generally constant value. Without the invention, the slaving of the converter in terms of output current can be achieved only with difficulty. Indeed, a measurement of the current passing through the second inductor L2, on average equal to a measurement of the output current, will be falsified if the inductors L1 and L2 have different values. By adding the third capacitor C3, the indirect measurement of the instantaneous output current comes considerably closer to the real value of the output current, doing so independently of the respective values of the values of L1 and L2 respectively. The slaving of the converter in terms of output current thus becomes possible without sidestepping the protection of the load circuit which is linked to the converter. As the invention makes it possible to use inductors of different values, the production of an SEPIC converter slaved in terms of output current is rendered easier and less expensive. Indeed, without the invention, such a converter can in practice be achieved only if the inductors L1 and L2 are selected so as to be exactly equal. If the inductors L1 and L2 are exactly equal, the effect of the residual ripple currents is less important on the indirect measurement of the output current. However, inductance components arising from mass production are rarely exactly equal. Therefore the practical implementation of such a converter according to the prior art gives rise to an expensive procedure for selecting the components, involving a series of tests, as well as a rejection of a significant number of components so as to guarantee exact correspondence between the inductors L1 and L2 used in the converter. This procedure is no longer necessary by virtue of the invention, which makes it possible to use inductance components arising from mass production such as inductors L1 and L2, without, however, impacting the performance of the converter in a negative manner. The sensitivity of the converter with respect to the values of inductors L1 and L2, as well as with respect to their coupling coefficient k, is reduced.

These and other objects and advantages of the invention will be apparent from the following description, the accompanying drawings and the appended claims.

### BRIEF DESCRIPTION OF THE ACCOMPANYING DRAWINGS

Other characteristics and advantages of the present invention will be better understood with the aid of the description and drawings among which:

FIG. 1 is a diagram illustrating a converter of SEPIC type known from the prior art;

FIGS. 2A, 2B and 2C show the temporal evolution of various signals measured during the operation of a converter of SEPIC type known from the prior art;

FIG. 3 is a diagram illustrating a converter of SEPIC type according to an embodiment of the invention;

FIGS. 4A, 4B and 4C show the temporal evolution of various signals measured during the operation of a converter of SEPIC type according to an embodiment of the invention.

### DETAILED DESCRIPTION OF THE PREFERRED EMBODIMENTS

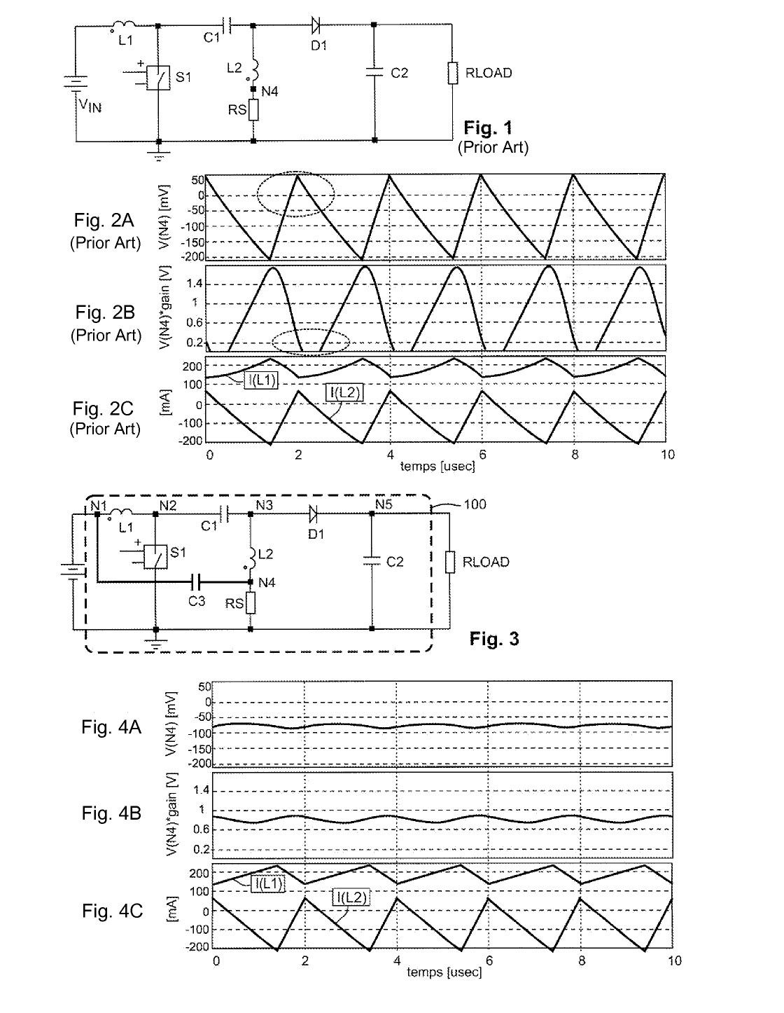

FIGS. 1 and 2A to 2C relate to a device known from the prior art and have been described above.

FIG. 3 shows diagrammatically the topology of a converter 100 of SEPIC type according to the invention. The converter is intended to convert a first DC voltage into a different second DC voltage. The second DC voltage, or output voltage, can be higher or lower than the first voltage, or input voltage. The converter comprises a first node N1, which serves to connect a voltage source linked to ground, which provides the first voltage VIN. In a preferential embodiment, the voltage VIN is provided by a 12V steel-lead battery. This is preferably the battery of a vehicle within which the converter is used to supply LEDs forming part of a lighting function of the vehicle. A first inductor L1 is coupled to the first node N1 and to a second node N2. This second node serves to link a first terminal of a switch S1, a second terminal of which is linked to ground. A first capacitor C1 is coupled to the second node N2 and to a third node N3. A second inductor L2 is coupled to the third node N3 and to a fourth node N4. A diode D1 is mounted between the third node N3 and a fifth node N5, in such a way that a current can flow from the third node N3 to the fifth node N5. The latter node serves to connect a load circuit illustrated by a resistor RLOAD, linked to ground. A second capacitor C2 is coupled to the fifth node N5 and to ground in a manner parallel with the load circuit. The fourth node N4 is linked to ground across a measurement resistor Rs. An additional branch links the first node N1 to the fourth node N4. This branch comprises at least one third capacitor C3.

The effect of adding the third capacitor C3 between the first node N1 and the fourth node N4 is a substantial diminution of the effect of the residual ripple currents arising from the inductors L1 and L2, on the current measured between the fourth node N4 and the ground. The effect of the ripple currents may be accentuated if the inductors L1 and L2 are not exactly equal, and it depends on their coupling coefficient k. The measured current, once the effect of the ripple currents has diminished, corresponds to the output current which passes through the load circuit. The basic operation of the SEPIC converter, capable of raising or of lowering the voltage VIN, is not affected by adding the third capacitor C3.

An illustration of this behavior of a converter according to the invention is provided by FIGS. 4A, 4B and 4C respectively. FIG. 4A shows the temporal evolution of the voltage between the fourth node N4 and the ground. FIG. 4B shows the same signal amplified by an operational amplifier. FIG. 4C shows the corresponding evolution of the currents passing through the inductors L1 and L2 respectively. By comparing the behavior illustrated by FIGS. 4A, 4B and 4C with the behavior of a known converter such as is illustrated by FIG. 2, the following observations are noted. The currents in the inductors L1 and L2 do not change. However, the voltage measured between the fourth node N4 and the ground changes. Indeed, by using the converter according to the invention, the voltage variations at the fourth node N4 are diminished or smoothed in a significant manner.

This explains in a general manner the underlying principle of the present invention.

The indirect measurement of the output current is preferably performed across the terminals of the measurement resistor Rs. In a known manner, the potential difference across the terminals of Rs and measured and amplified, and the corresponding current is obtained by applying Ohm's law.

The device preferably comprises a slaving loop, not illustrated, which makes it possible to adjust the duty ratio of closing of the switch S1 as a function of the indirect measurement of the output current. The production of such slaving means is known per se in the prior art and will not be described in detail during this description. As the voltage applied to the load circuit depends on the duty ratio of closing of the switch S1, the slaving loop is able to apply a generally stable voltage to the load circuit, and to provide it with a generally constant current.

In an exemplary preferred application, the converter is used to produce a device for driving the electrical power supply of light-emitting diodes, LED. The luminous intensity of an LED varies linearly with the current passing through it. This is why it is important to supply one or more LEDs, mounted in series as load circuit of the converter, through a generally constant current. The constant current generates a constant luminous intensity. Since the converter according to the invention is of SEPIC type, a constant luminous intensity can be produced even if the starting potential V_{IN} fluctuates over time. This characteristic renders the device according to the invention particularly suitable for automotive vehicle lighting signaling systems. In applications of this kind, the input voltage may fluctuate as a function of the spiky demands of diverse electrical systems within the vehicle. All the onboard systems may be supplied by one and the same battery. However, the luminous intensity of the signaling LEDs must be constant.

This is why, preferably, the converter according to the invention is slaved so as to provide a current and a voltage to the diodes suitable for carrying out at least one predetermined luminous function of an automotive vehicle. The plurality of LEDs driven with the aid of the converter of the invention is preferably designed to carry out at least one predetermined luminous function of an automotive vehicle, such as a daytime light, a position light, a fog light, a direction indicator, lighting of dipped headlight type or lighting of full beam headlight type.

The converter according to the invention allows the production of a current supply which is reliable and easy to produce, since the converter slaving current gives a realistic indication of the load current, even if the inductors L1 and L2 are not exactly identical.

The rating of the third capacitor C3 is done in such a way that the potential difference between the fourth node N4 and the ground, the evolution of which is illustrated by FIG. 4A, does not change sign. Computing means for simulating circuits known per se in the prior art make it possible to evaluate the third capacitor C3 as a function of L1, L2, k and of the output current. The rating is chosen such that in the worst case the potential difference between the fourth node N4 and the ground does not change sign during the operation of the converter.

Alternatively, the value of C3 can be calculated in an analytical manner by calculations which are known per se in the art. In the case where V(N4)<<VIN, the current I(L2) which passes through the secondary inductor L2 is not influenced, and it is possible to consider the inductor to be a current source. When the switch is open, i.e. between the instant 0<t<DT, this source delivers the current:

$${i}_{L 2} ( t ) = {i}_{Out} + Δ {I}_{L 2} \frac{2 t - DT}{2 DT}$$

The current of C3:

$${i}_{C 3} ( t ) = {C}_{3} \frac{d {V}_{C 3} ( t )}{d t}$$

The sum of the currents:

i_{Rs}(t)=i_{L2}(t)+i_{C3}(t)

The current in Rs can be expressed thus:

$${i}_{Rs} ( t ) = \frac{{V}_{IN} - {V}_{C 3} ( t )}{{R}_{S}}$$

The sum of the currents then becomes:

$$\frac{{V}_{I N} - {V}_{C 3} ( t )}{Rs} = ( {i}_{Out} + Δ {I}_{L 2} \frac{2 t - DT}{2 DT} ) + {C}_{3} \frac{d {V}_{C 3} ( t )}{d t}$$

$$\frac{{V}_{IN}}{{R}_{S}} - ( {i}_{Out} + Δ {I}_{L 2} \frac{2 t - DT}{2 DT} ) = + {C}_{3} \frac{d {V}_{C 3} ( t )}{d t} + \frac{{V}_{C 3} ( t )}{{R}_{S}}$$

$${V}_{IN} - {R}_{S} ( {i}_{Out} + Δ {I}_{L 2} \frac{2 t - DT}{2 DT} ) = + {R}_{S} {C}_{3} \frac{d {V}_{C 3} ( t )}{d t} + {V}_{C 3} ( t )$$

The solution for V_{C3}(t) makes it possible to rate the capacitor C3:

$${V}_{C 3} ( t ) = \frac{2 {C}_{3} Δ {I}_{L 2} {R}_{S}^{2} + DT ( Δ {I}_{L 2} {R}_{S} - 2 {i}_{Out} {R}_{S} + 2 {V}_{IN} ) - 2 Δ {I}_{L 2} {R}_{S} \cdot t}{2 DT} + A {e}^{- \frac{t}{{R}_{s} {C}_{3}}}$$

with the constant A which depends on the initial conditions.

The converter described can be produced with the aid of components well known per se in the prior art. It may for example be produced as a printed circuit, PIB, which may comprise other components assigned to other applications. The switch is preferably embodied as a transistor, and more particularly as a MOSFET insulated gate field-effect transistor.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A converter of SEPIC type intended to convert a first DC voltage into a different second DC voltage, comprising:
a first node N1, which serves to connect a voltage source linked to ground, which provides the first voltage V_{IN};
a first inductor L1 coupled to said first node N1 and to a second node N2;
a switch S1 comprising a first contact coupled to said second node N2, and a second contact coupled to ground;
a first capacitor C1 coupled to said second node N2 and to a third node N3;
a second inductor L2 coupled to said third node N3 and to a fourth node N4;
a diode D1 mounted between said third node N3 and a fifth node N5 in such a way that a current can flow from said third node N3 to said fifth node N5, which serves to connect a load circuit linked to ground;
a second capacitor C2 coupled to said fifth node N5 and to ground;
a measurement resistor Rs mounted between said fourth node N4 and the ground;
and wherein said converter comprises a branch which links said first node N1 to said fourth node N4, and which comprises a third capacitor C3.

2. The converter according to claim 1, wherein the value of said first inductor L1 is different from said second inductor L2.

3. The converter according to claim 1, wherein said first inductor L1 and said second inductor L2 are coupled.

4. The converter according to claim 1, wherein said switch is a transistor.

5. The converter according to claim 1, wherein said switch is a MOSFET insulated gate field-effect transistor.

6. The converter according to claim 1, in which said capacitor C3 is rated in such a way that the potential difference between said fourth node N4 and the ground does not change during the operation of said converter.

7. A device for driving the electrical power supply of light-emitting diodes, LED, for an automotive vehicle, comprising a converter of SEPIC type, wherein said converter is in accordance with claim 1.

8. The device according to claim 7, wherein said device comprises current measurement means disposed so as to measure the electric current between said fourth node N4 and the ground, corresponding to an indirect measurement of the output current of said converter.

9. The device according to claim 8, wherein said converter is slaved in terms of output current through said indirect measurement of said output current.

10. A device for an automotive vehicle, especially a lighting or signaling device, comprising a plurality of LEDs and a device for driving the power supply of said plurality of LEDs, wherein said driving device is in accordance with claim 7.

11. A method of power supply of at least one light-emitting diode, LED, mounted as load circuit of a converter of SEPIC type according to claim 1 and supplied by a first voltage source VIN, wherein said method comprises the steps of:
indirect measurement of said output current of said converter by measurement of the electric current between said fourth node N4 and the ground; and
slaving of said converter in terms of output current through said indirect measurement.

12. The method according to claim 11, wherein at least two light-emitting diodes, LED, are mounted in series in said load circuit.

13. The converter according to claim 2, wherein said first inductor L1 and said second inductor L2 are coupled.

14. The converter according to claim 2, wherein said switch is a transistor.

15. The converter according to claim 3, wherein said switch is a transistor.

16. The converter according to claim 2, wherein said switch is a MOSFET insulated gate field-effect transistor.

17. The converter according to claim 2, in which said capacitor C3 is rated in such a way that the potential difference between said fourth node N4 and the ground does not change during the operation of said converter.

18. A device for driving the electrical power supply of light-emitting diodes, LED, for an automotive vehicle, comprising a converter of SEPIC type, wherein said converter is in accordance with claim 2.

19. The device according to claim 2, wherein said device comprises current measurement means disposed so as to measure the electric current between said fourth node N4 and the ground, corresponding to an indirect measurement of the output current of said converter.

20. The device according to claim 2, wherein said converter is slaved in terms of output current through said indirect measurement of said output current.
